(19) United States
(12) Patent Application Publication
(10) Pub. No.: US 2020/0276642 A1
(43) Pub. Date: Sep. 3, 2020

(54) Method for manufacturing multi-material component and multi-material component

(71) Applicant: Teknologian tutkimuskeskus VTT Oy, Espoo (FI)

(72) Inventors: Alejandro Revuelta, VTT (FI); Antero Jokinen, VTT (FI); Antti Pasanen, Tampere (FI); Tomi Lindroos, Tampere (FI)

(73) Assignee: Teknologian tutkimuskeskus VTT Oy, Espoo (FI)

(21) Appl. No.: 16/649,707

(22) PCT Filed: Sep. 6, 2018
(86) PCT No.: PCT/FI2018/050629

§ 371 Date: Mar. 23, 2020

(30) Foreign Application Priority Data
Sep. 25, 2017 (FI) 20175849

(51) Int. Cl. B22F 3/15; B22F 3/105; B22F 7/08

(52) U.S. Cl. CPC B22F 3/15; B22F 3/1055; B33Y 10/00; B22F 2998/10; B22F 7/08

(57) ABSTRACT

A method for manufacturing a multi-material component, including manufacturing a part with at least one internal channel and/or cavity open to an outer surface of the part with additive manufacturing method, such as selective laser melting, from a first material, filling after manufacturing the part from the first material, the at least one channel and/or cavity in the part with at least one second material, where the open area of the at least one channel and/or cavity at the surface of the part is covered, and subjecting the at least one second material to a hot isostatic pressing in which the part manufactured from the first material forms part of the high-pressure containment vessel for the second material. Further disclosed is such a multi-material component.

The present invention relates to manufacturing multi-material components, where additive manufacturing method is utilized. More precisely the present invention relates to a method for manufacturing a multi-material component with sections of at least two different materials and to such a multi-material component.

Additive manufacturing, also known as 3D printing, refers to processes used to create 3D objects and components, where the objects are created layer by layer under computer control, often utilizing digital model data of 3D computer models of the product to be manufactured. Additive manufacturing processes allow for a multitude of shapes to be produced, without the restrictions of traditional “subtracting manufacturing” such as machining processes which require access for the machining tool substantially to all surfaces to be machined.

For example, ISO/ASTM 52900:2015 defines a plurality of different additive manufacturing processes including material extrusion, material jetting, powder bed fusion and sheet lamination, among others.

Publication EP 2 700 459 discloses a method for manufacturing a tree-dimensional article, wherein the article is built up from a metallic base material by means of an additive manufacturing process, and heat treating said manufactured article. In one disclosed embodiment, the article is manufactured by selective laser melting (SLM) and the heat treatment to the manufactured article is done by hot isostatic pressing (HIP).

Publication EP 3 064 295 discloses a process for producing an article, which is near-net shape component. The process includes forming a consolidation shell by additive manufacturing, which shell defines an interior space having a geometry corresponding to the component, the shell is filled with metallic powder, and the metallic powder is consolidated, with HIP for example. The consolidation shell may be removed from the manufactured component with a plurality of different methods disclosed in the publication.

Publication WO 97/19776 discloses a method for fabricating a fully-dense three-dimensional metal article, wherein a skin of the metal article, operating as a “can” for HIP, is produced with selective laser sintering. The “can” for HIP may or may not be removed from the article, as desired.

Publication EP 3 210 703 discloses a method for manufacturing a tool body, which comprises a formation of a solid outer jacket with additive manufacturing, which is then filled with material in liquid or powder form, and the filling material is then solidified. When using powder filling material, the solidification may be done with HIP.

Manufacturing of multi-material components with the additive manufacturing is challenging, and often impossible, especially with techniques utilizing metal powders, due to the mixing of the different metal powders for different sections of the component, among other problems.

The present invention provides a solution for allowing manufacturing process for multi-material components by utilizing additive manufacturing combined with hot isostatic pressing. This way the advantages of additive manufacturing for component design can be fully utilized in the multi-material component.

In the method of the present invention for manufacturing a multi-material component a part with at least one internal channel and/or cavity open to the outer surface of the part is manufactured with additive manufacturing method, such as selective laser melting, from a first material. After manufacturing the part from the first material, the at least one channel and/or cavity in the part is filled with at least one second material, the open area of the at least one channel and/or cavity at the surface of the part is covered, and the second material is subjected to a hot isostatic pressing in which the part manufactured from the first material forms part of the high-pressure containment vessel for the second material.

In the present invention, the first material is in powder form before the solidification during the additive manufacturing step, and the technique used to solidify the powder is preferably selective laser melting (SLM).

By hot isostatic pressing the second material inside the manufactured part of first material even very complex multi-material components may be manufactured with substantially easily. By utilizing the manufactured part as a part of the required high-pressure containment vessel the containment vessel is easily created by closing the openings of the internal channels and/or cavities for the second material inside the manufactured part.

In an embodiment of the method of the invention the first material is metal material, such as stainless steel, for example. The main requirement for the first material is that it must have sufficient strength, closed porosity and other characteristics suitable for forming a part of the high-pressure containment vessel for hot isostatic pressing. The first material may also be a mixture of materials, such as metal matrix composite material that deforms plastically during hot isostatic pressing, for example.

In an embodiment of the method of the invention the second material is in powder form before the hot isostatic pressing, and is preferably metal powder material. This allows for a proper filling of even most complex internal channels and cavities inside the part formed from the first material. The second materials may also be mixture of materials comprising metals and ceramics, such as metal matrix composites.

It is to be noted that in the present invention bonding between the first material and the at least one second material it is not always necessary, and the non-bonding can even be a desirable feature for some components. In the non-bonding case the form of the internal channels and/or cavities inside the part from the first material keep the solid material together in the manufactured component.

In an embodiment of the method of the invention the open area of the at least one channel and/or cavity at the surface of the part is covered by welding a metal piece over it in the part manufactured from the first material, which welding is preferably done by electron beam welding, to form the high-pressure containment vessel for hot isostatic pressing. Alternatively, the covering of the open area or areas of the internal channels and/or cavities can be done by additional additive manufacturing method, in which the cover may be formed from the first material. Some of the covers may also be formed during the first stage additive manufacturing of the part, which covers can then be later machined off from the finalized component.

Electron beam welding is advantageous within the concept of the present invention, since the vacuum required by the welding can be used also in the degassing of the second material powder(s) simultaneously with the closing of the channels and cavities.

In an embodiment of the method of the invention the cover over the open area of the at least one channel and/or cavity at the surface of the part is removed after the hot isostatic pressing, preferably together with some of the material of the part.

In an embodiment of the method of the invention the manufactured multi-material component is a part of an electric motor, a heat transfer component, a loadbearing component, or a part of a mold for injection molding or other manufacturing process.

The present invention also provides a multi-material component, which component comprises sections of first material and at least one second material, wherein the at least one second material is partially enclosed inside the first material, wherein the section of the first material in the component is formed with additive manufacturing method, and that the section of the at least one second material is formed with hot isostatic pressing partially inside the formed section of the first material.

In an embodiment of the multi-material component of the invention the first material is metal material, preferably steel, and more preferably stainless steel.

In an embodiment of the multi-material component of the invention the second material is in powder form before hot isostatic pressing, and is preferably metal powder material.

In an embodiment of the multi-material component of the invention the manufactured multi-material component is a part of an electric motor, a heat transfer component, or a loadbearing component.

The features defining a method according to the present invention are disclosed more precisely in claim 1, and the features defining a multi-material component according to the present invention are disclosed more precisely in claim 7. Dependent claims disclose advantageous embodiments and features of the invention.

Exemplifying embodiment of the invention and its advantages are explained in greater detail below in the sense of example and with reference to accompanying drawings, where

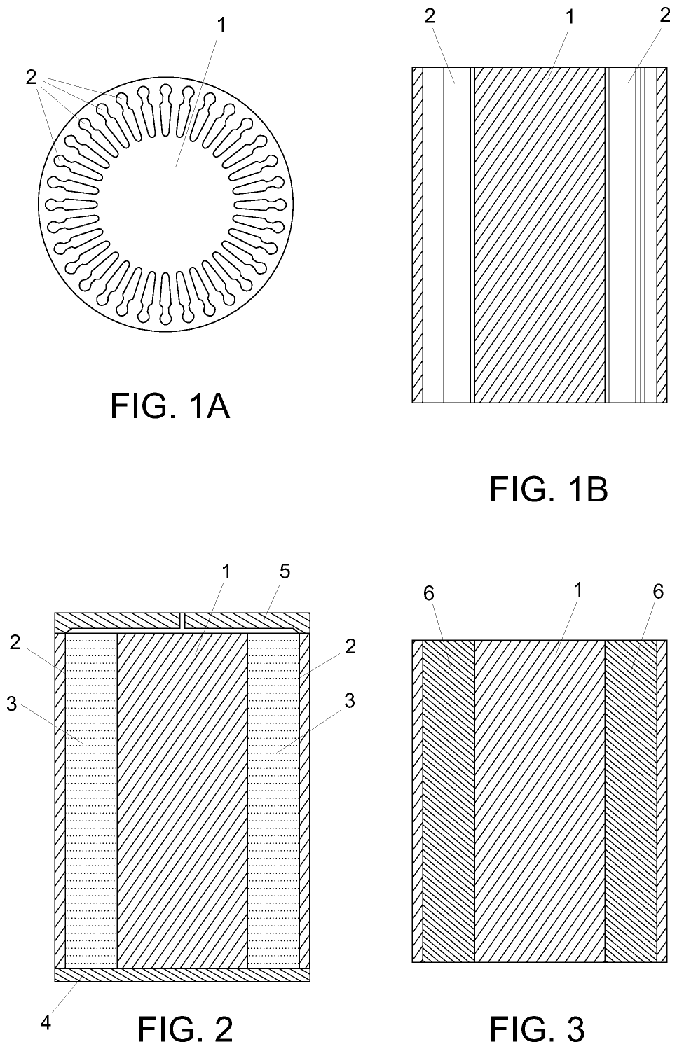

FIGS. 1A and 1B show schematically a part manufactured from the first material in accordance with the present invention,

FIG. 2 shows schematically the part of FIGS. 1A and 1B prepared for hot isostatic pressing of the second material, and

FIG. 3 shows schematically the finalized multi-material component of the invention.

In the figures is shown an example of the method steps for manufacturing a multi-material component in accordance with the present invention, which multi-material component in this case is a rotor of an electric machine.

FIGS. 1A and 1B show schematically a part manufactured from a first material, which is this case is the frame part 1 of a rotor. FIG. 1A shows the frame part 1 as a top view and FIG. 1B shows the frame part from a cross-sectional side view.

The frame part 1 is manufactured by selective laser melting (SLM), wherein metal powder is melt with a laser in phases layer by layer until the final product height is reached. A 3D computer model is used in the process, which is sliced in predetermined thicknesses to create a plurality of vector scanning sections of each layer to be formed during the manufacturing process. These layers are then utilized to operate the SLM machine to produce the 3D part. The metal powder used is stainless steel powder to obtain stainless steel frame part 1.

The frame part 1 comprises a plurality of straight internal channels 2 extending along the length of the frame part as can be seen from FIG. 1B. The channels 2 are placed in the frame part 1 based on the predefined locations for the required bar windings.

FIG. 2 shows schematically the frame part 1 prepared for hot isostatic pressing of the second material, which is this case is copper powder 3.

First, at one end of the frame part 1 is welded a metal plate 4, which closes the channels 2 at their one end. Then the channels 2 are filled with copper powder 3, and a cover 5 is welded on the opposite end of the frame part 1 in relation to the metal plate 4. The cover 5 is preferably welded with electron beam welding, wherein the copper powder 3 is degassed simultaneously with hermetical sealing of the cover in vacuum to make the component suitable for the hot isostatic pressing. The cover 5 also comprises required channels for forwarding the required high-pressure effect to the channels 2 and the copper powder 3 within them during the hot isostatic pressing. As can be seen from FIG. 2, the frame part 1 itself forms part of the high-pressure containment vessel for the hot isostatic pressing, since only its end sections are covered with the metal plate 4 and the cover 5.

The other end of the frame part 1 can also be closed during the manufacturing of the frame part 1 by SLM by adding a solid layer at one end of the frame part 1 so that the channels 2 are open only at one end of the frame part 1. This eliminates the need for welding the metal plate 4 at one end of the frame part 1 before the hot isostatic pressing.

After the copper powder 3 is solidified to solid copper bars 6 inside the frame part 1 with hot isostatic pressing, the metal plate 4 and the cover 5 are removed from the multi-material component obtained by the hot isostatic pressing. The removal of the metal plate 4 and the cover 5 are preferably done so, that a portion of the formed multi-material component (1, 6) is removed together with the metal plate and the cover. This way the effect of the shrinkage in the copper bars 6 during the solidification of copper powder 3 can be removed from the finalized multi-material component.

If the metal plate 4 is replaced by a solid section of the frame part 1, then this solid section is machined away from the formed multi-material component to allow access to the end surfaces of the copper bars 6.

The specific exemplifying embodiment of the invention shown in figures and discussed above should not be construed as limiting. A person skilled in the art can amend and modify the embodiment in many evident ways within the scope of the attached claims. Thus, the invention is not limited merely to the embodiment described above.

1. A method for manufacturing a multi-material component, comprising:
manufacturing a part with at least one internal channel and/or cavity open to an outer surface of the part with additive manufacturing method, such as selective laser melting, from a first material,
filling after manufacturing the part from the first material, the at least one channel and/or cavity in the part with at least one second material, wherein the open area of the at least one channel and/or cavity at the surface of the part is covered, and
subjecting the at least one second material to a hot isostatic pressing in which the part manufactured from the first material forms part of the high-pressure containment vessel for the second material.

2. The method according to claim 1, wherein the first material is a metal material in powder form before the additive manufacturing step.

3. The method according to claim 1, wherein the second material is in powder form before the hot isostatic pressing, and is preferably a metal powder material.

4. The method according to claim 2, wherein the open area of the at least one channel and/or cavity at the surface of the part is covered by welding a metal piece over it in the part manufactured from the first material, which welding is preferably done by electron beam welding, to form the high-pressure containment vessel for hot isostatic pressing.

5. The method according to claim 1, wherein the cover over the open area of the at least one channel and/or cavity at the surface of the part is removed after the hot isostatic pressing, preferably together with some of the material of the part.

6. The method according to claim 1, wherein the manufactured multi-material component is a part of an electric motor, a heat transfer component, or a loadbearing component.

7. A multi-material component, comprising sections of a first material and at least one second material, wherein the at least one second material is partially enclosed inside the first material, wherein the section of the first material in the component is formed with additive manufacturing method, and that a section of the at least one second material is formed with hot isostatic pressing partially inside the formed section of the first material.

8. The multi-material component according to claim 7, wherein the first material is a metal material and in powder form before forming with additive material method.

9. The multi-material component according to claim 7, wherein the second material is in powder form before hot isostatic pressing, and is preferably a metal powder material.

10. The multi-material component according to claim 7, wherein the manufactured multi-material component is a part of an electric motor, a heat transfer component, or a loadbearing component.
